(19) United States
(12) Patent Application Publication
(10) Pub. No.: US 2026/0236202 A1
(43) Pub. Date: Aug. 13, 2026

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Satoshi KAWAMURA, Kanagawa (JP)

(73) Assignee: FUJIFILM Business Innovation Corp., Tokyo (JP)

(21) Appl. No.: 19/311,517

(22) Filed: Aug. 27, 2025

(30) Foreign Application Priority Data
Feb. 13, 2025 (JP) 2025-021831

(51) Int. Cl. G06F 3/12

(52) U.S. Cl. CPC G06F 3/1222; G06F 3/1204; G06F 3/1238; G06F 3/1267; G06F 3/1285

(57) ABSTRACT

An information processing system includes a processor configured to: acquire user identification information and user authentication information that is used for authentication in combination with the user identification information; in a case where the authentication based on the user identification information and the user authentication information is successful, grant access to a function regarding personal information; after granting access to the function regarding the personal information, in a case where a predetermined condition is satisfied, request provision of information that matches information that has been used for the authentication; and after requesting provision of the information that matches the information that has been used for the authentication, in a case where the information that matches the information that has been used for the authentication is not acquired, prohibit continued access to the function regarding the personal information.

### CROSS-REFERENCE TO RELATED APPLICATIONS

This application is based on and claims priority under 35 USC 119 from Japanese Patent Application No. 2025-021831 filed February 13, 2025.

### BACKGROUND

### (i) Technical Field

The present disclosure relates to an information processing system, an information processing method, and a non-transitory computer readable medium.

### (ii) Related Art

In Japanese Unexamined Patent Application Publication No. 2015-161971, an automatic logout apparatus is disclosed. The automatic logout apparatus includes non-operation determining means for determining whether or not, after a job instructed by a user is executed, the user does not perform any operation without logging out, terminal apparatus determining means for determining whether or not, in a case where it is determined that the user does not perform any operation, a terminal apparatus of the user is operated, and user authenticating means for, in a case where it is determined that the terminal apparatus of the user is operated, logging the user out.

### SUMMARY

Information processing systems may provide a function regarding personal information of users. For example, multifunction machines installed in public spaces may provide a function for printing certificates of users. In information processing systems providing such a function, authentication of a user is first performed. If authentication is successful, the user is granted access to the function regarding personal information. There has been a problem that if a user who has been granted access to the function regarding personal information moves away from an operation screen, an outsider may gain continued access to the function regarding personal information.

Aspects of non-limiting embodiments of the present disclosure relate to providing an information processing system, an information processing method, and a non-transitory computer readable medium preventing, compared to a case where, after a user has been granted access to a function regarding personal information through authentication, provision of information that matches information that has been used for the authentication is not requested, continued access to the function regarding personal information by an outsider.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire user identification information and user authentication information that is used for authentication in combination with the user identification information; in a case where the authentication based on the user identification information and the user authentication information is successful, grant access to a function regarding personal information; after granting access to the function regarding the personal information, in a case where a predetermined condition is satisfied, request provision of information that matches information that has been used for the authentication; and after requesting provision of the information that matches the information that has been used for the authentication, in a case where the information that matches the information that has been used for the authentication is not acquired, prohibit continued access to the function regarding the personal information.

### BRIEF DESCRIPTION OF THE DRAWINGS

Exemplary embodiments of the present disclosure will be described in detail based on the following figures, wherein:

FIG. 1 is a diagram illustrating an example of the configuration of a function providing system including an information processing system according to an exemplary embodiment of the present disclosure;

FIG. 2 is a diagram illustrating an example of the hardware configuration of an information processing system according to an exemplary embodiment of the present disclosure;

FIG. 3 is a diagram illustrating an example of the functional configuration of an information processing system according to an exemplary embodiment of the present disclosure;

FIG. 4 is a diagram illustrating an example of a flowchart of an information process performed by an information processing system according to an exemplary embodiment of the present disclosure;

FIG. 5 is a diagram illustrating an example of a flowchart of a matching information requesting process in step S112 of the flowchart in FIG. 4; and

FIG. 6 is a diagram illustrating an example of a flowchart of a continued-access-to-function prohibition process in step S114 of the flowchart in FIG. 4.

### DETAILED DESCRIPTION

Hereinafter, exemplary embodiments of the present disclosure will be described with reference to drawings. In the drawings, the same reference signs are assigned to the same or equivalent component elements and parts. Furthermore, dimensional ratios in the drawings are exaggerated for the convenience of explanation and may differ from actual ratios.

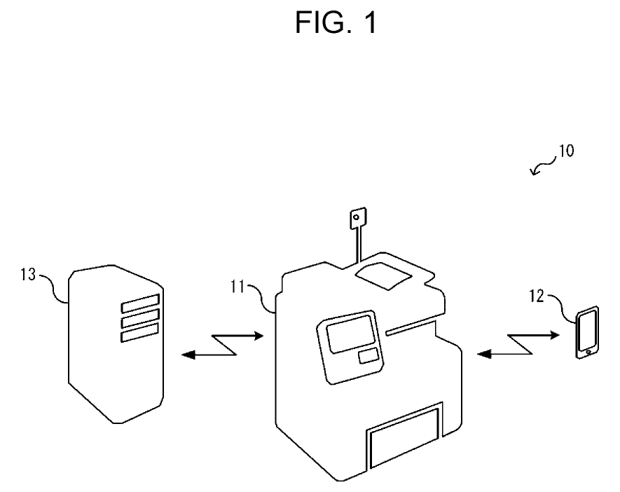

First, a configuration of a function providing system 10 according to an exemplary embodiment of the present disclosure will be described with reference to FIG. 1.

FIG. 1 is a diagram illustrating an example of the configuration of the function providing system 10 according to an exemplary embodiment of the present disclosure. The function providing system 10 includes an information processing system 11, an information recording medium 12, and a server 13.

As a function provided by the function providing system 10 regarding personal information, a function for printing a certificate of a user and issuing the certificate to the user is available. The certificate is, for example, a copy of a residence certificate, a registered seal certificate, or a family register certificate. FIG. 1 illustrates an example of the state in which the function providing system 10 provides the function regarding personal information mentioned above.

Specifically, the information processing system 11 checks whether or not a user who is operating an operation screen of the information processing system 11 has the authority to access a function regarding personal information before granting the user access to the function regarding personal information. The information processing system 11 communicates with the information recording medium 12 of the user and requests provision of user identification information. The user identification information is information for identifying the user. The user identification information is, for example, a user identification number. However, the user identification information is not limited to information such as the user identification number. The user identification information may be any type of information that is able to be used to check whether or not the user is a registered user. The information recording medium 12 holds user identification information and provides the user identification information to the information processing system 11. The information processing system 11 requests the user to input user authentication information and acquires the user authentication information. The user authentication information is, for example, a password. However, the user authentication information is not limited to information based on knowledge of the user. The user authentication information may be any type of information that is able to be used for authentication in combination with the user identification information.

The information processing system 11 encrypts the user identification information and the user authentication information and transmits the encrypted user identification information and user authentication information to the external server 13. In this processing, the information processing system 11 holds information that has been used for authentication so that the information is able to be referenced in a later step. In this example, the information processing system 11 holds the user identification information. The server 13 transmits an authentication result obtained based on the received information to the information processing system 11. In the case where it is confirmed, based on the authentication result, that the user who is operating the operation screen has the authority to access the function, the information processing system 11 grants the user access to the function regarding personal information.

After access to the function has been granted, at a time in the period during which access to the function is granted, the person who uses the information processing system 11 may be switched from the granted user to an outsider. For example, the granted user moves away from the information processing system 11 and goes to a car to get a wallet while a screen that allows a copy of a residence certificate to be printed is being displayed on a display screen of the information processing system 11. While the granted user is away, an outsider who is near the information processing system 11 may try to access the information processing system 11.

Thus, to check whether or not the person who is trying to access the function regarding personal information is an outsider, in the case where a predetermined condition is satisfied, the information processing system 11 requests provision of information that matches the information that has been used for the authentication. For example, the information processing system 11 requests again the information recording medium 12 with which the information processing system 11 is communicating to provide the user identification information. The information that has been used for the authentication is information used when the authentication by the server 13 was successful. Based on the information, checking whether the person who is using the information processing system 11 is the granted user and is not an outsider is performed. After acquiring the information, the information processing system 11 compares the acquired information with the held user identification information. In the case where it is determined that information that matches the held user identification information is acquired, the information processing system 11 grants continued access to the function regarding personal information. In the case where it is determined that information that matches the held user identification information is not acquired, the information processing system 11 prohibits continued access to the function regarding personal information.

In the function providing system 10, as described above, the information processing system 11, the information recording medium 12, and the server 13 exchange data, and the function regarding personal information is provided.

The information processing system 11 is, for example, a multifunction machine. The multifunction machine is an apparatus that has functions of a copier, a printer, an image scanner, a facsimile, and the like. However, the information processing system 11 is not limited to an apparatus that prints images and may be any type of apparatus that provides the function regarding personal information. For example, the information processing system 11 may be an apparatus that is installed in a public space such as a convenience store, a library, a district office, or a shared office.

The information recording medium 12 is, for example, a terminal. The terminal is, for example, a mobile phone, a digital camera, a tablet terminal, a desktop personal computer, a laptop personal computer, an all-in-one personal computer, a tablet personal computer, or the like. However, the information recording medium 12 is not limited to an electronic device such as a terminal and may be any type of medium on which user identification information is recorded. For example, the information recording medium 12 may be an IC card such as an individual number card on which an electronic certificate is recorded. The information recording medium 12 may be an information recording medium that is capable of contact communication or an information recording medium that is capable of contactless communication.

Hereinafter, an information recording medium capable of contact communication may be referred to as a contact-type information recording medium. For example, the contact-type information recording medium is a contact-type IC card. The contact-type IC card is physically placed in contact with a reader so that data exchange is performed. For example, the contact-type information recording medium often needs to be inserted into a reader.

Hereinafter, an information recording medium capable of contactless communication may be referred to as a contactless-type information recording medium. For example, the contactless-type information recording medium is a terminal. The terminal is capable of data exchange with the information processing system 11 through wireless communication, for example, by using a function of an application. Furthermore, the terminal is capable of data exchange, without direct contact, by being placed over a reader, for example, using a function of an application. Furthermore, for example, the contactless-type information recording medium is a contactless-type IC card. The contactless-type IC card is capable of data exchange, without direct contact, by being placed over a reader. The contactless-type information recording medium often performs data exchange while being held in a hand. Therefore, the probability that a contactless-type information recording medium is left behind seems to be lower than the probability that a contact-type information recording medium is left behind. Furthermore, the probability that a contactless-type information recording medium that performs data exchange with an apparatus through wireless communication is left behind seems to be lower than the probability that a contactless-type information recording medium that performs data exchange by being placed over a reader is left behind. This is because a user may place the contactless-type information recording medium on the reader when placing the contactless-type information recording medium over the reader.

If the information recording medium 12 on which user identification information is recorded is left behind, personal information may be exploited by an outsider. In the case where the information recording medium 12 is a contact-type information recording medium, it is desirable that the frequency of use of the information recording medium 12 to check whether or not the person who is trying to access the function regarding personal information is an outsider be low. However, it is desirable that, in terms of secure provision of the function regarding personal information, the frequency of checking whether or not the person who is trying to access the function regarding personal information is an outsider be high. Thus, in an exemplary embodiment, the information processing system 11 may check, using a method in which the information processing system 11 communicates with a contactless-type information recording medium, whether or not the person who is trying to access the function regarding personal information is an outsider. The information processing system 11 according to an exemplary embodiment reduces the risk that the information recording medium 12 will be left behind even if the frequency of checking using the information recording medium 12 increases.

In this example, the server 13 is an apparatus that stores user identification information registered in advance and user authentication information that is paired with the user identification information, receives encrypted user identification information and user authentication information from another apparatus such as the information processing system 11, and outputs an authentication result.

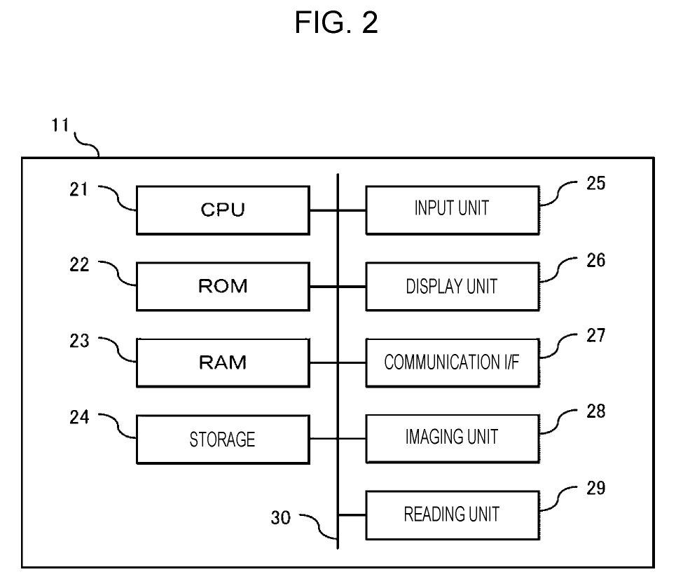

Next, a hardware configuration of the information processing system 11 according to an exemplary embodiment of the present disclosure will be described with reference to FIG. 2.

FIG. 2 is a diagram illustrating an example of the hardware configuration of the information processing system 11 according to an exemplary embodiment of the present disclosure. The information processing system 11 includes a central processing unit (CPU) 21, a read only memory (ROM) 22, a random access memory (RAM) 23, a storage 24, an input unit 25, a display unit 26, a communication interface (communication I/F) 27, an imaging unit 28, and a reading unit 29. These components are connected in such a manner that they are able to communicate with one another via a bus 30.

The CPU 21 is a central processing unit. The CPU 21 executes various programs and controls various units. That is, the CPU 21 reads a program from the ROM 22 or the storage 24 and executes the program by using the RAM 23 as a work area. The CPU 21 performs control of the components mentioned above and various arithmetic processes on the basis of a program recorded in the ROM 22 or the storage 24. In this exemplary embodiment, an information processing program is stored in the ROM 22 or the storage 24.

Various programs and various data are stored in the ROM 22. A program or data is temporarily stored in the RAM 23 as a work area. The storage 24 includes a hard disk drive (HDD) or a solid state drive (SSD). Various programs including an operating system and various data are stored in the storage 24.

The input unit 25 includes a pointing device such as a mouse and a keyboard and is used to perform various inputs. The display unit 26 is, for example, a liquid crystal display and displays various types of information. The display unit 26 may be of a touch panel type and may also function as the input unit 25.

The communication interface 27 is an interface for communicating with other apparatuses such as the information recording medium 12 and the server 13. For example, standards such as Wi-Fi (registered trademark), Bluetooth (registered trademark), Zigbee (registered trademark), near field communication (NFC), Ethernet (registered trademark), or fiber distributed data interface (FDDI) are used for the communication interface 27.

The imaging unit 28 is, for example, a camera. Image information obtained by imaging is used to determine whether or not leaving, approaching, or replacement of a person occurs in an imaging area, such as an area in front of the information processing system 11. Such a determination about a change of a person in the imaging area may be performed using face recognition technology, motion recognition technology, or the like.

The reading unit 29 is a reader that reads information from the information recording medium 12. The reading unit 29 is, for example, a contact-type card reader/writer or a contactless-type card reader/writer.

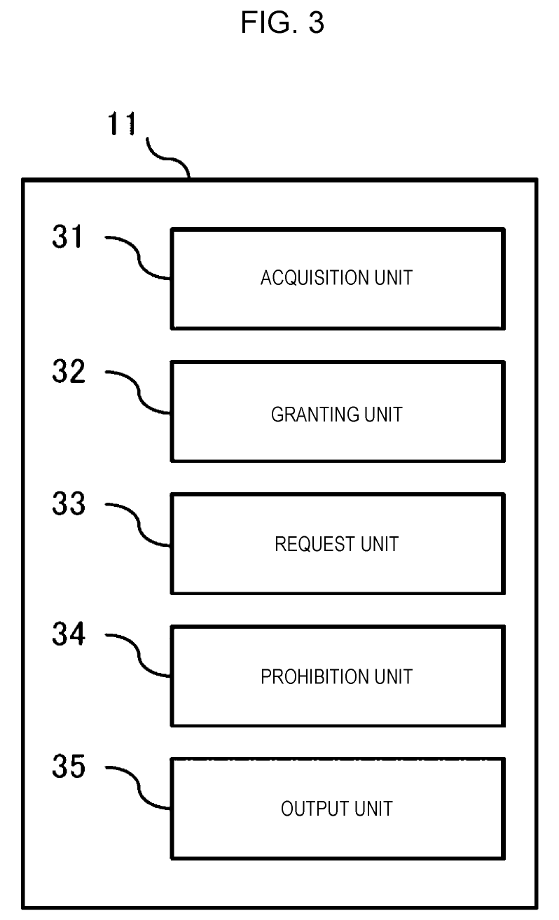

Next, a functional configuration of the information processing system 11 according to an exemplary embodiment of the present disclosure will be described with reference to FIG. 3.

FIG. 3 is a diagram illustrating an example of the functional configuration of the information processing system 11 according to an exemplary embodiment of the present disclosure. The information processing system 11 includes, as the functional configuration, an acquisition unit 31, a granting unit 32, a request unit 33, a prohibition unit 34, and an output unit 35. The functional configuration mentioned above is implemented by the CPU 21 reading the information processing program stored in the ROM 22 or the storage 24, loading the information processing program onto the RAM 23, and executing the information processing program.

The acquisition unit 31 acquires user identification information and user authentication information to be used for authentication in combination with the user identification information. The acquisition unit 31 also holds information that has been used for the authentication. For example, the acquisition unit 31 holds user identification information.

The granting unit 32 grants access to the function regarding personal information. For example, in the case where authentication based on user identification information and user authentication information is successful, the granting unit 32 grants access to the function regarding personal information. Furthermore, the granting unit 32 grants continued access to the function regarding personal information. For example, after requesting provision of information that matches information that has been used for authentication, in the case where information that matches the information that has been used for the authentication is acquired, the granting unit 32 grants continued access to the function regarding personal information.

The request unit 33 requests provision of information that matches information that has been used for authentication. For example, in the case where a predetermined condition is satisfied, the request unit 33 requests provision of information that matches information that has been used for authentication. Furthermore, for example, in the case where the function regarding personal information is still being used and the predetermined condition is satisfied, the request unit 33 requests provision of information that matches information that has been used for authentication. Furthermore, the request unit 33 requests provision of information that matches user identification information, as information that matches information that has been used for authentication. For example, in the case where user identification information has been acquired from a contactless-type information recording medium that is capable of contactless communication, and after access to the function regarding personal information has been granted, in the case where the predetermined condition is satisfied, the request unit 33 requests the contactless-type information recording medium to provide, through contactless communication, information that matches the user identification information. Furthermore, for example, in the case where user identification information has been acquired from a contact-type information recording medium that is capable of contact communication, and after access to the function regarding personal information has been granted, in the case where the predetermined condition is satisfied, the request unit 33 requests the contact-type information recording medium to provide, through contact communication, information that matches the user identification information.

The prohibition unit 34 prohibits continued access to the function regarding personal information. For example, after requesting provision of information that matches information that has been used for authentication, in the case where information that matches the information that has been used for the authentication is not acquired, the prohibition unit 34 prohibits continued access to the function regarding personal information. Furthermore, for example, after requesting again, for example, by outputting a message, provision of information that matches the information that has been used for the authentication, in the case where information that matches the information that has been used for the authentication is not acquired, the prohibition unit 34 maintains prohibition of continued access to the function regarding personal information. Furthermore, for example, in the case where the function regarding personal information has finished being used, the prohibition unit 34 prohibits access to the function regarding personal information. For example, the prohibition unit 34 does not execute a function corresponding to a predetermined operation. For example, in the case where a predetermined operation is detected, after requesting provision of information that matches information that has been used for authentication, if information that matches the information that has been used for the authentication is not acquired, the prohibition unit 34 does not execute a function corresponding to the predetermined operation. Furthermore, the prohibition unit 34 does not allow personal information to be output in a visible manner. For example, in the case where an operation for outputting personal information in a visible manner is detected, after requesting provision of information that matches information that has been used for authentication, if information that matches the information that has been used for the authentication is not acquired, the prohibition unit 34 does not allow personal information to be output in a visible manner.

The output unit 35 outputs a message indicating that the terminal is not unlocked. For example, after requesting the terminal to provide, through contactless communication, information that matches user identification information, in the case where information that matches the user identification information is not acquired from the terminal through contactless communication, the output unit 35 outputs a message indicating that the terminal is not unlocked. Furthermore, the output unit 35 outputs a message indicating that an application is not being displayed on the terminal in such a manner that the application is able to be operated. For example, in the case where user identification information has been acquired through an application operated on the terminal, after requesting provision of information that matches user identification information, if information that matches the user identification information is not acquired, the output unit 35 outputs a message indicating that the application is not being displayed on the terminal in such a manner that the application is able to be operated. Furthermore, the output unit 35 outputs a message to prevent a contact-type information recording medium from being left behind. For example, in the case where user identification information has been acquired from a contact-type information recording medium that is capable of contact communication, after requesting provision of information that matches the user identification information, if information that matches the user identification information is acquired from a contact-type information recording medium, the output unit 35 outputs a message to prevent the contact-type information recording medium from being left behind.

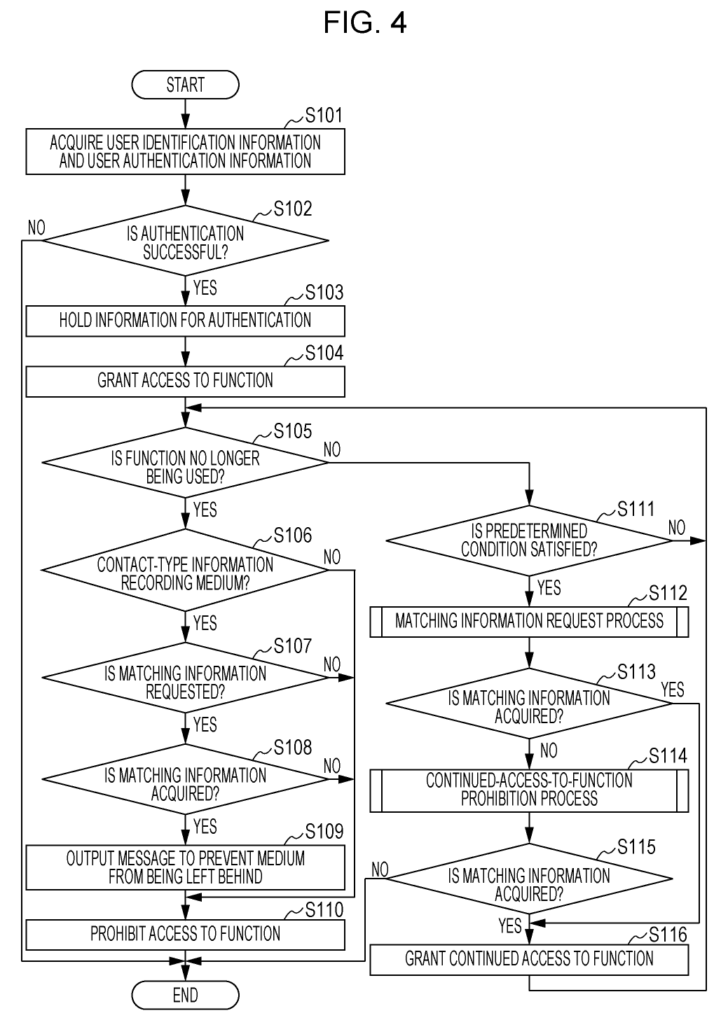

Next, a process performed by the information processing system 11 according to an exemplary embodiment of the present disclosure will be described with reference to FIG. 4.

FIG. 4 is a diagram illustrating an example of a flowchart of an information process performed by the information processing system 11 according to an exemplary embodiment of the present disclosure. The information process is performed by the CPU 21 reading the information processing program from the ROM 22 or the storage 24, loading the information processing program onto the RAM 23, and executing the information processing program. This flowchart starts in a state in which access to the function regarding personal information is not granted on the display of the display unit 26, that is, in a state in which login is not done.

In step S101, the CPU 21, as the acquisition unit 31, acquires user identification information and user authentication information to be used for authentication in combination with the user identification information. The CPU 21 acquires the user identification information and the user authentication information so as to query the server 13 about whether or not a person who is trying to operate the information processing system 11 is a registered user. The CPU 21 may acquire the user identification information by communicating with the information recording medium 12 of the user to request provision of the user identification information. The CPU 21 may acquire the user authentication information by requesting the user to input the user authentication information to the input unit 25.

The user identification information may be acquired in one or a plurality of methods. For example, the user identification information may be provided through short-range wireless communication by an operation of placing a contactless-type IC card over the reading unit 29. The user identification information may be acquired through an application operated on a terminal as the information recording medium 12. For example, the user identification information may be provided through communication connection, such as NFC or Bluetooth, using a function of an application operated on a terminal as the information recording medium 12. In such a case, the information processing system 11 may perform connection through communication, which is so-called pairing, with the terminal as the information recording medium 12. The user identification information may be acquired from a contact-type information recording medium that is capable of contact communication. For example, the user identification information may be provided from a contact-type IC card inserted in the reading unit 29. Apart from step S109, which will be described later, a message to prevent a contact-type information recording medium from being left behind may be output at this stage. Information about in which method the user identification information was acquired may be stored so that the information is able to be used in later processing.

Next, the CPU 21 proceeds to step S102.

In step S102, the CPU 21, as the granting unit 32, determines whether or not authentication based on the user identification information and the user authentication information is successful. Specifically, the CPU 21 encrypts the user identification information and the user authentication information acquired in step S101 and transmits the encrypted user identification information and user authentication information to the external server 13. After that, the CPU 21 determines, based on information output from the server 13, whether or not the authentication is successful.

In the case where it is determined that the authentication is successful, the CPU 21 proceeds to step S103. In the case where it is determined that the authentication is not successful, the CPU 21 causes the display on the display unit 26 not to grant access to the function regarding personal information and ends the information process.

In step S103, the CPU 21, as the acquisition unit 31, holds information that has been used for the authentication. The information that has been used for the authentication may be at least one of the user identification information and the user authentication information acquired in step S101.

The held information is referenced in step S113, which will be described later, and is used for matching of information. By holding the information as described above, there is no need to query the server 13 in the processing of step S113. That is, in authentication of the user for the first time, the information processing system 11 transmits encrypted user identification information and user authentication information to the external server 13. Then, the information processing system 11 receives an authentication result from the server 13. In step S113, which will be described later, the CPU 21 determines whether or not information that matches the information that has been used for the authentication is acquired, without querying the server 13. Typically, it requires a certain amount of time to query an external server about information. In the present disclosure, determination as to whether or not information that matches information that has been used for authentication is acquired may be performed a plurality of times. Thus, it is desirable that, in terms of user-friendliness, the time required to perform a single determination be shortened. Therefore, in step S103, the CPU 21, as the acquisition unit 31, holds the information that has been used for the authentication. After predetermined processing steps are completed, the CPU 21 may dispose of data regarding the information held in step S103.

Next, the CPU 21 proceeds to step S104.

In step S104, the CPU 21, as the granting unit 32, grants access to the function regarding personal information.

Specifically, the CPU 21 causes the display on the display unit 26 to enter a logged-in state. By causing the display on the display unit 26 to enter the logged-in state, for example, the CPU 21 causes the display unit 26 to display a screen that allows selection regarding the type of a certificate required by the user, items to be stated in the certificate, the number of copies to be printed, and the like.

Next, the CPU 21 proceeds to step S105.

In step S105, the CPU 21, as the request unit 33, determines whether or not the function regarding personal information has finished being used.

Specifically, in the case where use of the function regarding personal information by the user is presumed to be stopped or terminated, the CPU 21 may determine that the function has finished being used. For example, in the case where an operation for voluntarily ending the use of the function has been performed, the CPU 21 may determine that the function has finished being used. The case where an operation for voluntarily ending the use of the function has been performed is, for example, a case where a “cancel” button or an “end” button displayed on the display unit 26 has been selected. Furthermore, for example, in the case where no input has been made to the input unit 25 for a certain period of time or more, that is, in the case where a time-out occurs, the CPU 21 may determine that the function has finished being used. Furthermore, for example, in the case where execution of a predetermined function is completed, the CPU 21 may determine that the function has finished being used. For example, in the case where printing of a certificate is performed and issuance of a receipt is completed, the CPU 21 may determine that the function has finished being used.

In known techniques, after a condition mentioned above is satisfied, processing for prohibiting access to the function regarding personal information as in step S110, which will be described later, for example, log-out processing, is performed. However, there has been a problem that an outsider may be able to gain continued access to the function regarding personal information before such a condition is satisfied. For example, there may be a situation in which, before a time-out occurs, a granted user moves away from the information processing system 11, and an outsider gains continued access to the function. In the present disclosure, before such a condition is satisfied, information that matches information that has been used for authentication is required and checking whether or not a person who is trying to access the function regarding personal information is an outsider is performed. As described above, in the present disclosure, continued access to the function regarding personal information by an outsider is prevented.

In the case where it is determined that the function regarding personal information has finished being used, the CPU 21 proceeds to step S106. Steps S106 to S108 are steps to determine whether or not to perform processing of step S109. In the case where it is determined that the function regarding personal information has not finished being used, the CPU 21 proceeds to step S110.

In step S106, the CPU 21, as the output unit 35, determines whether or not the user identification information has been acquired from a contact-type information recording medium that is capable of contact communication. This determination is performed because, in the case where the user identification information has been acquired from a contact-type information recording medium, the user may place the contact-type information recording medium on the reading unit 29 and may leave the contact-type information recording medium behind on the reading unit 29.

Specifically, the CPU 21 may determine whether or not the user identification information, which has been acquired in step S101, has been obtained by reading by the reading unit 29. Even in the case where a contactless-type information recording medium is used, the user may place the contactless-type information recording medium on the reading unit 29 and may leave the contactless-type information recording medium behind on the reading unit 29. Therefore, any user identification information read using the reading unit 29 may be considered similarly to user identification information acquired from a contact-type information recording medium, regardless of whether the information recording medium from which the user identification information has been acquired is strictly categorized as a contact-type information recording medium.

In the case where it is determined that the user identification information has been acquired from a contact-type information recording medium, the CPU 21 proceeds to step S107. In the case where it is determined that the user identification information has not been acquired from a contact-type information recording medium, the CPU 21 proceeds to step S110.

In step S107, the CPU 21, as the output unit 35, determines whether or not provision of information that matches the user identification information has been requested. This determination is performed because, in the case where provision of information that matches the user identification information has been requested, the user may place the information recording medium 12 on the reading unit 29 and may leave the information recording medium 12 behind on the reading unit 29. Specifically, the CPU 21 determines whether or not provision of information that matches the user identification information has been requested, as described later in step S112.

In the case where it is determined that communication of information that matches the user identification information has been requested, the CPU 21 proceeds to step S108. In the case where it is determined that communication of information that matches the user identification information has not been requested, the CPU 21 proceeds to step S110.

In step S108, the CPU 21, as the output unit 35, determines whether or not information that matches the user identification information has been acquired from a contact-type information recording medium. This determination is performed because, in the case where information that matches the user identification information has been acquired by reading by the reading unit 29, the user may place the information recording medium 12 on the reading unit 29 and may leave the information recording medium 12 behind on the reading unit 29.

Specifically, the CPU 21 may determine whether or not information that matches the user identification information has been acquired by reading by the reading unit 29. Even in the case where a contactless-type information recording medium is used, the user may place the contactless-type information recording medium on the reading unit 29 and may leave the contactless-type information recording medium behind on the reading unit 29. Therefore, as long as the information that matches the user identification information has been read using the reading unit 29, the information may be considered similarly to information that matches the user identification information acquired from a contact-type information recording medium, regardless of whether the medium is strictly categorized as a contact-type information recording medium.

In the case where it is determined that information that matches the user identification information has been acquired from a contact-type information recording medium, the CPU 21 proceeds to step S109. Proceeding from step S108 to S109 means that it has been determined that the contact-type information recording medium may be, for example, inserted into the reading unit 29 and may be left behind on the reading unit 29. In the case where it is determined that information that matches the user identification information is not acquired from a contact-type information recording medium, the CPU 21 proceeds to step S110.

In step S109, the CPU 21, as the output unit 35, outputs a message to prevent the contact-type information recording medium from being left behind.

Specifically, the CPU 21 causes the display unit 26 to display a message “Please remove your card.” Even in the case where a contactless-type information recording medium is used, the user may place the contactless-type information recording medium on the reading unit 29 and may leave the contactless-type information recording medium behind on the reading unit 29. Therefore, as long as the information that matches the user identification information has been read using the reading unit 29, such a message may be output in a similar manner, regardless of whether the medium is strictly categorized as a contact-type information recording medium. In this example, for better user-friendliness, after it is determined that the function has finished being used and before logging out is done, a message to prevent the information recording medium from being left behind is output. For example, when execution of printing is completed, at the time when the user shifts their focus to a printed material and the likelihood that the user will leave the information recording medium behind increases, the CPU 21 outputs a message to prevent the information recording medium from being left behind. In another example, every time provision of information that matches the user identification information is requested, a message to prevent the information recording medium from being left behind may be output.

In the case where provision of information that matches user identification information is requested in a state in which the information recording medium is held in a user’s hand, the information recording medium is less likely to be left behind. Therefore, even if the number of times such a request is made increases, the risk of leaving behind is relatively small. However, in the case where provision of information that matches user identification information by reading of the information recording medium that is not held in the user’s hand by the reading unit 29 is requested, the probability that the information recording medium will be left behind is relatively high. Therefore, by outputting a message to prevent the contact-type information recording medium from being left behind, a situation in which the contact-type information recording medium is left behind is suppressed.

Next, the CPU 21 proceeds to step S110.

In step S110, the CPU 21, as the prohibition unit 34, prohibits access to the function regarding personal information.

Specifically, the CPU 21 switches the display on the display unit 26 from the logged-in state to the logged-out state.

Then, the CPU 21 ends the information process.

In step S111, the CPU 21, as the request unit 33, determines whether or not a predetermined condition is satisfied. Step S111 is a step for determining whether or not provision of information that matches the information that has been used for the authentication is to be requested in step S112, which will be described later.

For example, the CPU 21 determines whether or not a condition that a predetermined operation among operations for executing the function regarding personal information is detected is satisfied. The operations for executing the function regarding personal information include operations that are problematic when performed by an outsider and operations that are not problematic even when performed by an outsider. The operations that are not problematic even when performed by an outsider include, for example, an operation for returning to the previous page. The operations that are problematic when performed by an outsider include, for example, an operation for outputting personal information in a visible manner. The operation for outputting personal information in a visible manner is, for example, an operation for printing a document including personal information. The operation for outputting personal information in a visible manner may be, for example, an operation for allowing a document containing personal information to be previewed before the document is printed.

By setting such an operation for outputting personal information in a visible manner as the predetermined operation, checking whether or not a person who is trying to access the function regarding personal information is an outsider is able to be performed, before the personal information is output in a visible manner. Unnecessarily frequent request for provision of information that matches information that has been used for authentication may excessively degrade user-friendliness. Thus, in the present disclosure, provision of information that matches information that has been used for authentication may be requested at the time when the predetermined operation is detected. By doing this, checking whether or not the person who is trying to access the function regarding personal information is an outsider is able to be performed without excessively degrading user-friendliness.

As another example, the CPU 21 determines whether or not a condition that a change of the person who is performing an operation for executing the function regarding personal information is detected is satisfied. Specifically, the CPU 21 uses information acquired from the imaging unit 28. For example, the CPU 21 determines, based on image information obtained by imaging, with the imaging unit 28, an area in front of the information processing system 11, whether or not leaving, approaching, or replacement of a person occurs in the area in front of the information processing system 11. Detecting a change of a person who is performing an operation for executing the function regarding personal information may be detecting that a person who was performing an operation for executing the function regarding personal information has left. Detecting a change of a person who is performing an operation for executing the function regarding personal information may be detecting that a person different from a person who was performing an operation for executing the function regarding personal information has approached the information processing system 11. Detecting a change of a person who is performing an operation for executing the function regarding personal information may be detecting that a person who was performing an operation for executing the function regarding personal information has been replaced by a different person. A method for detecting a change of a person who is performing an operation for executing the function regarding personal information is not limited to a method using the imaging unit 28. A sensor in another aspect may be installed in the information processing system 11 so that a change of a person is detected by the sensor. Furthermore, in a case where a device for detecting the motion of a person is provided in a facility in which the information processing system 11 is installed, information may be acquired from the device. In the present disclosure, provision of information that matches information that has been used for authentication may be requested at the time when a change of a person who is performing an operation for executing the function regarding personal information is detected. Thus, checking whether or not a person who is trying to access the function regarding personal information is an outsider is able to be performed without excessively degrading user-friendliness.

As still another example, the CPU 21 determines whether or not a condition that a predetermined interval time has passed is satisfied. For example, the CPU 21 determines whether or not a condition that one minute has passed since display on the display unit 26 turned to the logged-in state in step S104 is satisfied. In the case where such a condition is set, every time the predetermined interval time has passed, the CPU 21 may request provision of information that matches information that has been used for authentication. For example, every time one minute has passed since display on the display unit 26 turned to the logged-in state, the CPU 21 may request provision of information that matches information that has been used for authentication. By setting a shorter interval time, an opportunity for an outsider to access the function is reduced, and access to the function regarding personal information by the outsider is able to be suppressed with an enhanced security.

As still another example, the CPU 21 determines whether or not at least one of a condition that a change of a person who is performing an operation for executing the function regarding personal information is detected and a condition that the predetermined interval time has passed is satisfied. As described above, the predetermined condition may be at least one of the condition that a predetermined operation among operations for executing the function regarding personal information is detected, the condition that a change of a person who is performing an operation for executing the function regarding personal information is detected, and the condition that the predetermined interval time has passed.

As still another example, the CPU 21 determines whether or not both the condition that a change of a person who is performing an operation for executing the function regarding personal information is detected and the condition that a predetermined operation among operations for executing the function regarding personal information is detected are satisfied. For example, the CPU 21 determines whether or not, after a person different from the person who was performing an operation for executing the function regarding personal information has approached, an operation for outputting personal information in a visible manner is detected. As described above, the predetermined condition may be a combination of a plurality of conditions.

Another example of the predetermined condition may be a condition that a terminal as the information recording medium 12 that has been connected by pairing with the information processing system 11 through NFC, Bluetooth, or the like in step S101 has moved a certain distance away from the information processing system 11. In the case where the terminal has left the information processing system 11, a user who carries the terminal with them has presumably left the information processing system 11. By requesting, at this time, provision of information that matches information that has been used for authentication, checking whether or not the person who is trying to access the function regarding personal information is an outsider is able to be performed without excessively degrading user-friendliness.

In the case where it is determined that the predetermined condition is satisfied, the CPU 21 proceeds to step S112. In the case where it is determined that the predetermined condition is not satisfied, the CPU 21 returns to step S105.

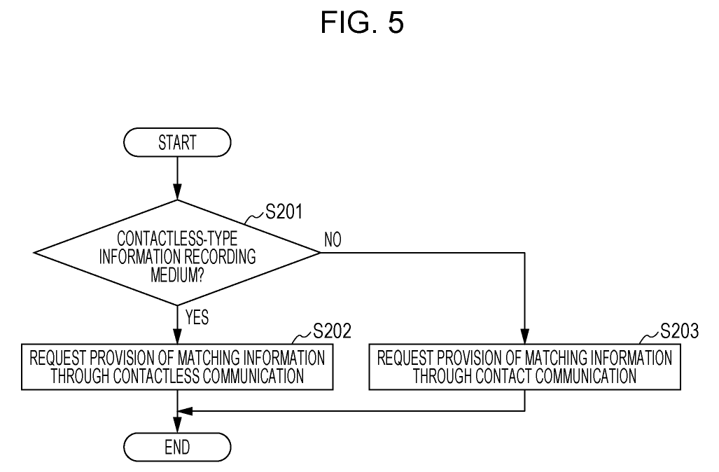

In step S112, the CPU 21, as the request unit 33, requests provision of information that matches the information that has been used for the authentication. Herein, requesting “provision of information that matches information that has been used for authentication” may be expressed as requesting “re-provision of information that has been used for authentication.” For example, the CPU 21, as the request unit 33, performs a matching information requesting process, as illustrated in FIG. 5.

FIG. 5 is a diagram illustrating an example of a flowchart of the matching information requesting process in step S112 of the flowchart in FIG. 4. In this example, a matching information requesting process for the case where provision of information that matches user identification information, out of the user identification information and the user authentication information acquired in step S101, as the information that matches the “information that has been used for the authentication” is requested will be described. The case where user identification information is acquired from an information recording medium and user authentication information is input by a user will be considered. In this case, by requesting provision of user identification information, which may be provided through communication using a medium, rather than user authentication information, which needs to be manually input, the annoyance for the user is able to be reduced. However, in another example, as information that matches the “information that has been used for the authentication,” information that matches the user authentication information, out of the user identification information and the user authentication information acquired in step S101, may be acquired. In this case, in the processing of step S112, the CPU 21 may display a message prompting the user to manually input again the user authentication information, for example, a password, on the display unit 26 of the information processing system 11. In any of the examples described above, the CPU 21 may, as the processing of step S112, request re-provision of the information that has been used for the authentication in the same way that the information was acquired in step S101.

In step S201, the CPU 21, as the request unit 33, determines whether or not the user identification information is acquired from a contactless-type information recording medium that is capable of contactless communication.

There may be a plurality of methods in which user identification information is provided by a contactless-type information recording medium. For example, the user identification information may be provided using a contactless-type IC card as the information recording medium 12. Furthermore, the user identification information may be provided using a terminal as the information recording medium 12. The CPU 21 determines in which method out of the plurality of possible methods the user identification information has been provided and acquired. The CPU 21 may reference the information stored in step S101 regarding a method in which the user identification information has been acquired.

In the case where it is determined that the user identification information is acquired by a contactless-type information recording medium, the CPU 21 proceeds to step S202. In the case where it is determined that the user identification information is not acquired from a contactless-type information recording medium, the CPU 21 proceeds to step S203. In this example, as the case where the user identification information is not acquired from a contactless-type information recording medium, a case where the user identification information is acquired from a contact-type information recording medium will be assumed.

In step S202, the CPU 21, as the request unit 33, requests the contactless-type information recording medium to provide information that matches the user identification information through contactless communication.

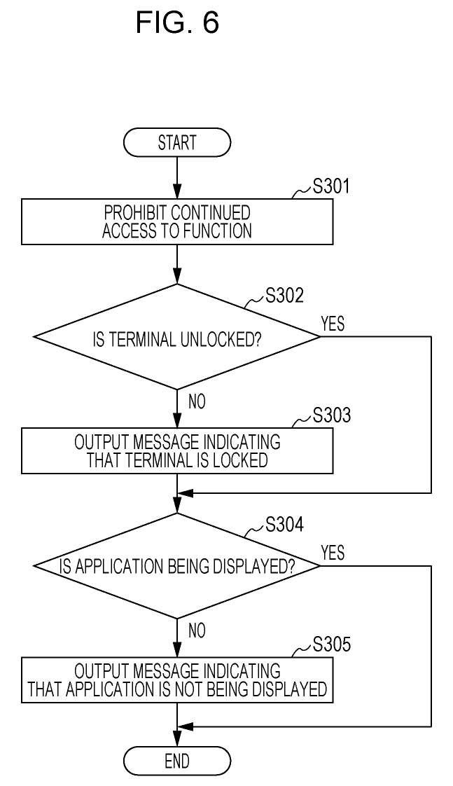

For example, the CPU 21 requests an application of a terminal as the information recording medium 12 to provide information that matches the user identification information in a state of being in communication. In this case, the CPU 21 transmits to the application of the terminal a signal for requesting re-provision of the user identification information. In the case where the application of the terminal is able to accept this request, the application of the terminal provides the user identification information. In the case where the application of the terminal is not able to accept the request, the application of the terminal provides to the information processing system 11 a reason why the request is not accepted. Processing for the case where the application of the terminal is not able to accept the request will be described later with reference to steps S301 to S305 of the flowchart in FIG. 6. For communication with a terminal to request provision as described above, the CPU 21 may notify the user of request for provision and then may request the user to operate the application or does not necessarily request the user to operate the application. By requesting the user for provision without requiring the user to perform an operation, the annoyance for the user is able to be reduced. Furthermore, in the case where the information processing system 11 requests a terminal that is connected through communication, so-called connected by pairing, to provide the user identification information again, it is confirmed not only that the same user identification information has been acquired but also that the same terminal has been used. Thus, in this case, the confirmation that the person who is using the information processing system 11 is not changed from the granted person to an outsider is achieved more reliably.

As another example, the CPU 21 requests provision of information that matches user identification information through contactless communication by placing a contactless-type IC card as the information recording medium 12 over the reading unit 29. In this case, the CPU 21 may display on the display unit 26 of the information processing system 11 a message prompting the user to place the IC card over the card reader. When an operation for placing the contactless-type IC card over the reading unit 29, the reading unit 29 is able to receive information from the contactless-type IC card.

In step S203, the CPU 21, as the request unit 33, requests a contact-type information recording medium to provide information that matches the user identification information through contact communication.

For example, the CPU 21 requests provision of information that matches the user identification information through contact communication by inserting a contact-type IC card as the information recording medium 12 into the reading unit 29. For example, the CPU 21 may display on the display unit 26 of the information processing system 11 a message prompting the user to insert the contact-type IC card into the card reader. As a result of such a request, the contact-type information recording medium may be left behind by, for example, being inserted into the reading unit 29. For such a case, the processing for preventing the contact-type information recording medium from being left behind is performed as described above in steps S106 to S109 of the flowchart in FIG. 4.

Then, the CPU 21 ends the matching information requesting process. Next, the CPU 21 proceeds to step S113 of the flowchart in FIG. 4. Details will be described below with reference back to FIG. 4.

In step S113, the CPU 21, as the prohibition unit 34, determines whether or not information that matches the information that has been used for the authentication is acquired.

Specifically, first, the CPU 21 determines, based on a result of the request in step S112, whether or not information is acquired within a certain period of time. In the case where no information is acquired, the CPU 21 determines that information that matches the information that has been used for the authentication is not acquired. In the case where information is acquired, the CPU 21 compares the acquired information with the information that has been used for the authentication and held in step S103. In the case where it is determined, based on the comparison result, that the acquired information does not match the held information, the CPU 21 determines that information that matches the information that has been used for the authentication is not acquired. In the case where it is determined, based on the comparison result, that the acquired information matches the held information, the CPU 21 determines that information that matches the information that has been used for the authentication is acquired. By comparing the acquired information with the information held in the information processing system 11, the CPU 21 is able to omit processing that will be required, for example, when querying an external server about information. In the case where provision of information that matches the information that has been used for the authentication is requested a plurality of times, shortening the processing time improves user-friendliness.

In the case where it is determined that information that matches the information that has been used for the authentication is not acquired, the CPU 21 proceeds to step S114. In the case where it is determined that information that matches the information that has been used for the authentication is acquired, the CPU 21 proceeds to step S116.

In step S114, the CPU 21, as the prohibition unit 34, prohibits continued access to the function regarding personal information. For example, the CPU 21 performs a continued-access-to-function prohibition process. The continued-access-to-function prohibition process will be described below with reference to FIG. 6.

FIG. 6 is a diagram illustrating an example of a flowchart of the continued-access-to-function prohibition process in step S114 of the flowchart in FIG. 4. In this example, the continued-access-to-function prohibition process for the case where information that matches the information that has been used for the authentication is not acquired because an application of the terminal that has a locking function was not able to accept a request for re-provision of the user identification information will be described. The locking function represents a function for making a predetermined function on the terminal unavailable unless a specific operation is performed so that the terminal is unlocked. For example, the locking function represents a function for not accepting an operation for an application on the terminal until the terminal has been unlocked. However, in another example, a situation in which information that matches the information that has been used for the authentication is not acquired because connection through communication between the terminal as the information recording medium 12 and the information processing system 11 is interrupted, may occur. In such a situation, the CPU 21 may display on the display unit 26 of the information processing system 11 a message indicating that communication is interrupted, instead of outputting a message described below.

In step S301, the CPU 21, as the prohibition unit 34, prohibits continued access to the function regarding personal information.

For example, the CPU 21 changes the display on the display unit 26 from the logged-in state to the logged-out state. Furthermore, for example, a case where, when the condition that the predetermined operation is detected is satisfied, the CPU 21 requests provision of information that matches the information that has been used for the authentication but does not acquire information that matches the information that has been used for the authentication will be considered. In such a case, the CPU 21, as the prohibition unit 34, does not execute a function corresponding to the predetermined operation. As another example, a case where, when the condition that the operation for outputting personal information in a visible manner is detected is satisfied, the CPU 21 requests provision of information that matches the information that has been used for the authentication but information that matches the information that has been used for the authentication is not acquired will be considered. In such a case, the CPU 21, as the prohibition unit 34, does not allow personal information to be output in a visible manner. As described above, in the case where information that matches the information that has been used for the authentication is not acquired in step S113, the CPU 21 prohibits continued access to the function regarding personal information because the person who is using the information processing system 11 may have been changed from the granted user to an outsider. In particular, the CPU 21 does not allow an operation that is problematic when performed by an outsider, such as the operation for outputting personal information in a visible manner, to be performed.

As still another example, the CPU 21 may switch the display screen on the display unit 26 to a screen displaying a message indicating that information that matches the information that has been used for the authentication is not acquired. As still another example, the CPU 21 may disable part of operations using the input unit 25.

Next, the CPU 21 proceeds to step S302.

In step S302, the CPU 21, as the output unit 35, determines whether or not the terminal is unlocked.

Specifically, the CPU 21 determines, based on the information from the terminal that has been connected through communication in step S112, whether or not the terminal is unlocked. The information from the terminal is information indicating that an application of the terminal is not able to accept the request for re-provision of the user identification information because the terminal is not unlocked.

As described above, the application of the terminal may be set to accept a request from the information processing system 11 only in a state in which the terminal is unlocked. Typically, a terminal is locked when a certain period of time has passed since the last operation on the terminal. Furthermore, an outsider is considered to be unable to unlock the terminal easily. Even in the case where a user of the terminal moves away from the information processing system 11 with the terminal left near the information processing system 11, if the terminal is locked, the terminal does not accept a request from the information processing system 11. Furthermore, even in the case where a user of the terminal carries the terminal with them, if the user does not intend to continuously use the function regarding personal information, the terminal may be locked. If the terminal is locked, the terminal does not accept a request from the information processing system 11.

In the case where it is determined that the terminal is not unlocked, the CPU 21 proceeds to step S303. In the case where it is determined that the terminal is unlocked, the CPU 21 proceeds to step S304.

In step S303, the CPU 21, as the output unit 35, outputs a message indicating that the terminal is not unlocked.

For example, the CPU 21 displays a message “The terminal is locked. Please unlock the terminal.” on the display unit 26. The message may be output in such a manner that the contents of the message is notified using sound from the information processing system 11. By outputting the message so that a person near the information processing system 11 who is trying to access the function regarding personal information is able to understand the message, the person may be prompted to unlock the terminal. Furthermore, by outputting such a message, checking whether or not information that matches the user identification information is acquired is able to be performed after that, and checking whether or not the person who is trying to access the function regarding personal information is an outsider, who is unable to unlock the terminal, is able to be performed.

Next, the CPU 21 proceeds to step S304.

In step S304, the CPU 21, as the output unit 35, determines whether or not the application is being displayed on the terminal in such a manner that the application is able to be operated.

Specifically, the CPU 21 determines, based on the information from the terminal that has been connected through communication in step S112, whether or not the application is being displayed on the terminal in such a manner that the application is able to be operated. The information from the terminal is information indicating that the application of the terminal is not able to accept the request for re-provision of the user identification information because the application is not being displayed on the terminal in such a manner that the application is able to be operated. The state in which the application is being displayed on the terminal in such a manner that the application is able to be operated may be regarded as a state in which the application is a so-called foregrounded.

As described above, the application of the terminal may be set to accept a request from the information processing system 11 only in a state in which the application is foregrounded. In the case where the terminal is carried by the user and located at a position where the terminal is able to communicate with the information processing system 11, there is a possibility that the user does not intend to continuously use the function regarding personal information because, for example, they are using another application. Unless the application of the terminal is foregrounded, the terminal does not accept a request from the information processing system 11.

In the case where it is determined that the application is not being displayed on the terminal in such a manner that the application is able to be operated, the CPU 21 proceeds to step S305. In the case where it is determined that the application is being displayed on the terminal in such a manner that the application is able to be operated, the CPU 21 ends the continued-access-to-function prohibition process.

In step S305, the CPU 21, as the output unit 35, output a message indicating that the application is not being displayed on the terminal in such manner that the application is able to be operated.

For example, the CPU 21 displays a message “The application is not being displayed. Please display the application.” on the display unit 26. The message may be output in such a manner that the contents of the message is notified using sound from the information processing system 11. By outputting the message so that a person near the information processing system 11 who is trying to access the function regarding personal information is able to understand the message, the person may be prompted to display the application on the terminal in such a manner that the application is able to be operated. Furthermore, by outputting such a message, checking whether or not information that matches the user identification information is acquired is able to be performed after that, and checking whether or not the person who is trying to access the function regarding personal information is an outsider, who is unable to display the application on the terminal in such a manner that the application is able to be operated, is able to be performed.

Then, the CPU 21 ends the continued-access-to-function prohibition process. Next, the CPU 21 proceeds to step S115 of the flowchart in FIG. 4. Details will be described below with reference back to FIG. 4.

In step S115, the CPU 21, as the prohibition unit 34, determines whether or not the information that matches the information that has been used for the authentication is acquired. This determination is performed because, as a result of requesting again provision of information that matches the information that has been used for re-authentication in relation to the processing of step S114, the CPU 21 may have acquired the information that matches the user identification information.

In the case where it is determined that the information that matches the user identification information is acquired, the CPU 21 proceeds to step S116. In the case where it is determined that the information that matches the user identification information is not acquired, the CPU 21 ends the information process.

In step S116, the CPU 21, as the granting unit 32, grants continued access to the function regarding personal information. That is, the CPU 21 maintains the state in which access to the function regarding personal information is granted in step S104 or grants again access to the function that was once prohibited in step S114. For example, the CPU 21 may allow a function corresponding to a predetermined operation to be executed. For example, the CPU 21 may allow personal information to be output in a visible manner. As described above, after the confirmation that the person who is trying to access the function regarding personal information is not an outsider is achieved, continued access to the function regarding personal information is able to be granted.

Next, the CPU 21 returns to step S105.

As described above, in the present disclosure, in a case where access to the function regarding personal information is granted to a user through authentication and a predetermined condition is satisfied, provision of information that matches information that has been used for the authentication is request, and checking whether or not a person who is trying to access the function regarding personal information is an outsider is performed. Thus, in the present disclosure, continued access to the function regarding personal information by an outsider is prevented.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. Furthermore, a program according to an exemplary embodiment of the present application may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:

a processor configured to:

acquire user identification information and user authentication information that is used for authentication in combination with the user identification information;

in a case where the authentication based on the user identification information and the user authentication information is successful, grant access to a function regarding personal information;

after granting access to the function regarding the personal information, in a case where a predetermined condition is satisfied, request provision of information that matches information that has been used for the authentication; and

after requesting provision of the information that matches the information that has been used for the authentication, in a case where the information that matches the information that has been used for the authentication is not acquired, prohibit continued access to the function regarding the personal information.

(((2)))

The information processing system according to (((1))), wherein the predetermined condition is at least one of a condition that a predetermined operation among operations for executing the function regarding the personal information is detected, a condition that a change of a person who is performing an operation for executing the function regarding the personal information is detected, and a condition that a predetermined interval time has passed.

(((3)))

The information processing system according to (((2))),

wherein in a case where the predetermined condition includes the condition that the predetermined operation is detected, the processor is configured not to:

after requesting provision of the information that matches the information that has been used for the authentication, in a case where the information that matches the information that has been used for the authentication is not acquired, execute a function corresponding to the predetermined operation.

(((4)))

The information processing system according to (((3))), wherein the predetermined operation is an operation for outputting the personal information in a visible manner, and the processor is configured not to:

after requesting provision of the information that matches the information that has been used for the authentication, in a case where the information that matches the information that has been used for the authentication is not acquired, allow the personal information to be output in the visible manner.

(((5)))

The information processing system according to any one of (((2))) to (((4))), wherein in a case where the predetermined condition includes the condition that the predetermined interval time has passed, the processor is configured to:

after granting access to the function regarding the personal information, every time the predetermined interval time has passed, request provision of the information that matches the information that has been used for the authentication.

(((6)))

The information processing system according to any one of (((1))) to (((5))), wherein the processor is configured to:

after requesting provision of the information that matches the information that has been used for the authentication, in a case where the information that matches the information that has been used for the authentication is acquired, grant continued access to the function regarding the personal information.

(((7)))

The information processing system according to any one of (((1))) to (((6))),

wherein the information that matches the information that has been used for the authentication is information that matches the user identification information, and the processor is configured to:

in a case where the user identification information has been acquired from an information recording medium that is capable of contactless communication, and after granting access to the function regarding the personal information, in a case where the predetermined condition is satisfied, request the information recording medium to provide the information that matches the user identification information through contactless communication, and after requesting provision of the information that matches the user identification information, in a case where the information that matches the user identification information is acquired from the information recording medium through contactless communication, grant continued access to the function regarding the personal information.

(((8)))

The information processing system according to (((7))),

wherein the information recording medium is a terminal provided with a locking function, and the processor is configured to:

after requesting the terminal to provide the information that matches the user identification information through contactless communication, in a case where the information that matches the user identification information is not acquired from the terminal through contactless communication, prohibit continued access to the function regarding the personal information and output a message indicating that the terminal is not unlocked.

(((9)))

The information processing system according to (((7))) or (((8))), wherein the information recording medium is a terminal and the processor is configured to:

in a case where the user identification information has been acquired through an application operated on the terminal, and after requesting provision of the information that matches the user identification information, in a case where the information that matches the user identification information is not acquired, prohibit continued access to the function regarding the personal information and output a message indicating that the application is not being displayed on the terminal in such a manner that the application is able to be operated.

(((10)))

The information processing system according to any one of (((1))) to (((9))), wherein the information that matches the information that has been used for the authentication is information that matches the user identification information, and the processor is configured to:

in a case where the user identification information has been acquired from an information recording medium that is capable of contact communication, and after requesting provision of the information that matches the user identification information, in a case where the information that matches the user identification information is acquired from the information recording medium, output a message to prevent the information recording medium from being left behind.

(((11)))

An information processing program for causing a computer to execute a process comprising:

acquiring user identification information and user authentication information that is used for authentication in combination with the user identification information;

in a case where the authentication based on the user identification information and the user authentication information is successful, granting access to a function regarding personal information;

after granting access to the function regarding the personal information, in a case where a predetermined condition is satisfied, requesting provision of information that matches information that has been used for the authentication; and

after requesting provision of the information that matches the information that has been used for the authentication, in a case where the information that matches the information that has been used for the authentication is not acquired, prohibiting continued access to the function regarding the personal information.

What is claimed is:

1. An information processing system comprising:
a processor configured to:
acquire user identification information and user authentication information that is used for authentication in combination with the user identification information;
in a case where the authentication based on the user identification information and the user authentication information is successful, grant access to a function regarding personal information;
after granting access to the function regarding the personal information, in a case where a predetermined condition is satisfied, request provision of information that matches information that has been used for the authentication; and
after requesting provision of the information that matches the information that has been used for the authentication, in a case where the information that matches the information that has been used for the authentication is not acquired, prohibit continued access to the function regarding the personal information.

2. The information processing system according to claim 1, wherein the predetermined condition is at least one of a condition that a predetermined operation among operations for executing the function regarding the personal information is detected, a condition that a change of a person who is performing an operation for executing the function regarding the personal information is detected, and a condition that a predetermined interval time has passed.

3. The information processing system according to claim 2, wherein in a case where the predetermined condition includes the condition that the predetermined operation is detected, the processor is configured not to:
after requesting provision of the information that matches the information that has been used for the authentication, in a case where the information that matches the information that has been used for the authentication is not acquired, execute a function corresponding to the predetermined operation.

4. The information processing system according to claim 3, wherein the predetermined operation is an operation for outputting the personal information in a visible manner, and the processor is configured not to:
after requesting provision of the information that matches the information that has been used for the authentication, in a case where the information that matches the information that has been used for the authentication is not acquired, allow the personal information to be output in the visible manner.

5. The information processing system according to claim 2, wherein in a case where the predetermined condition includes the condition that the predetermined interval time has passed, the processor is configured to:
after granting access to the function regarding the personal information, every time the predetermined interval time has passed, request provision of the information that matches the information that has been used for the authentication.

6. The information processing system according to claim 3, wherein in a case where the predetermined condition includes the condition that the predetermined interval time has passed, the processor is configured to:
after granting access to the function regarding the personal information, every time the predetermined interval time has passed, request provision of the information that matches the information that has been used for the authentication.

7. The information processing system according to claim 4, wherein in a case where the predetermined condition includes the condition that the predetermined interval time has passed, the processor is configured to:
after granting access to the function regarding the personal information, every time the predetermined interval time has passed, request provision of the information that matches the information that has been used for the authentication.

8. The information processing system according to claim 1, wherein the processor is configured to:
after requesting provision of the information that matches the information that has been used for the authentication, in a case where the information that matches the information that has been used for the authentication is acquired, grant continued access to the function regarding the personal information.

9. The information processing system according to claim 2, wherein the processor is configured to:
after requesting provision of the information that matches the information that has been used for the authentication, in a case where the information that matches the information that has been used for the authentication is acquired, grant continued access to the function regarding the personal information.

10. The information processing system according to claim 3, wherein the processor is configured to:
after requesting provision of the information that matches the information that has been used for the authentication, in a case where the information that matches the information that has been used for the authentication is acquired, grant continued access to the function regarding the personal information.

11. The information processing system according to claim 4, wherein the processor is configured to:
after requesting provision of the information that matches the information that has been used for the authentication, in a case where the information that matches the information that has been used for the authentication is acquired, grant continued access to the function regarding the personal information.

12. The information processing system according to claim 1, wherein the information that matches the information that has been used for the authentication is information that matches the user identification information, and the processor is configured to:
in a case where the user identification information has been acquired from an information recording medium that is capable of contactless communication, and after granting access to the function regarding the personal information, in a case where the predetermined condition is satisfied, request the information recording medium to provide the information that matches the user identification information through contactless communication, and after requesting provision of the information that matches the user identification information, in a case where the information that matches the user identification information is acquired from the information recording medium through contactless communication, grant continued access to the function regarding the personal information.

13. The information processing system according to claim 12, wherein the information recording medium is a terminal provided with a locking function, and the processor is configured to:
after requesting the terminal to provide the information that matches the user identification information through contactless communication, in a case where the information that matches the user identification information is not acquired from the terminal through contactless communication, prohibit continued access to the function regarding the personal information and output a message indicating that the terminal is not unlocked.

14. The information processing system according to claim 12, wherein the information recording medium is a terminal, and the processor is configured to:
in a case where the user identification information has been acquired through an application operated on the terminal, and after requesting provision of the information that matches the user identification information, in a case where the information that matches the user identification information is not acquired, prohibit continued access to the function regarding the personal information and output a message indicating that the application is not being displayed on the terminal in such a manner that the application is able to be operated.

15. The information processing system according to claim 13, wherein the information recording medium is a terminal, and the processor is configured to:
in a case where the user identification information has been acquired through an application operated on the terminal, and after requesting provision of the information that matches the user identification information, in a case where the information that matches the user identification information is not acquired, prohibit continued access to the function regarding the personal information and output a message indicating that the application is not being displayed on the terminal in such a manner that the application is able to be operated.

16. The information processing system according to claim 1, wherein the information that matches the information that has been used for the authentication is information that matches the user identification information, and the processor is configured to:
in a case where the user identification information has been acquired from an information recording medium that is capable of contact communication, and after requesting provision of the information that matches the user identification information, in a case where the information that matches the user identification information is acquired from the information recording medium, output a message to prevent the information recording medium from being left behind.

17. The information processing system according to claim 2, wherein the information that matches the information that has been used for the authentication is information that matches the user identification information, and the processor is configured to:
in a case where the user identification information has been acquired from an information recording medium that is capable of contact communication, and after requesting provision of the information that matches the user identification information, in a case where the information that matches the user identification information is acquired from the information recording medium, output a message to prevent the information recording medium from being left behind.

18. The information processing system according to claim 3, wherein the information that matches the information that has been used for the authentication is information that matches the user identification information, and the processor is configured to:
in a case where the user identification information has been acquired from an information recording medium that is capable of contact communication, and after requesting provision of the information that matches the user identification information, in a case where the information that matches the user identification information is acquired from the information recording medium, output a message to prevent the information recording medium from being left behind.

19. An information processing method comprising:
acquiring user identification information and user authentication information that is used for authentication in combination with the user identification information;
in a case where the authentication based on the user identification information and the user authentication information is successful, granting access to a function regarding personal information;
after granting access to the function regarding the personal information, in a case where a predetermined condition is satisfied, requesting provision of information that matches information that has been used for the authentication; and
after requesting provision of the information that matches the information that has been used for the authentication, in a case where the information that matches the information that has been used for the authentication is not acquired, prohibiting continued access to the function regarding the personal information.

20. A non-transitory computer readable medium storing a program causing a computer to execute a process for information processing, the process comprising:
acquiring user identification information and user authentication information that is used for authentication in combination with the user identification information;
in a case where the authentication based on the user identification information and the user authentication information is successful, granting access to a function regarding personal information;
after granting access to the function regarding the personal information, in a case where a predetermined condition is satisfied, requesting provision of information that matches information that has been used for the authentication; and
after requesting provision of the information that matches the information that has been used for the authentication, in a case where the information that matches the information that has been used for the authentication is not acquired, prohibiting continued access to the function regarding the personal information.
